(19) United States
(12) Patent Application Publication
(10) Pub. No.: US 2004/0235599 A1
(43) Pub. Date: Nov. 25, 2004

(54) Load spreader

(76) Inventors: Michel Ozorak, St. Thomas (CA); Trevor Armstrong, London (CA); Yahya Hodjat, Oxford, MI (US)

Correspondence Address: THE GATES CORPORATION, IP LAW DEPT. 10-A3, 1551 WEWATTA STREET, DENVER, CO, 80202, US

(21) Appl. No.: 10/849,274

(22) Filed: May 19, 2004

Related U.S. Application Data
(60) Provisional application No. 60/472,385, filed on May 20, 2003.

(51) Int. Cl. F16H 55/49; F16H 55/36; F16H 7/20

(52) U.S. Cl. 474/199; 474/170

(57) ABSTRACT

A load spreader for use in pulley assemblies, where the load spreader engages the bearing and not the axle bolt, thereby allowing a single sized load spreader to be utilized with various sized axle bolts. The load spreader comprises a planar surface having a bore, and at least two arms disposed about the bore, with the arms extending substantially perpendicular from the planar surface which engage a bearing inner surface.

### FIELD OF THE INVENTION

This invention relates to the field of idler pulley assemblies, more particularly, this invention relates to a load spreader for distributing loads between a bearing of an idler pulley and a member to which the idler pulley is attached to, and a method of assembling such an idler pulley.

### BACKGROUND OF THE INVENTION

Power transmission through a belt occasionally requires the belt to change directions in order to avoid other components. For this, the belt can be trained over one or more idler pulleys that allow the belt direction to be changed with minimal loss of efficiency. Further, an idler pulley may be installed on a tensioner pivot arm in order to provide tensioning for the belt.

Idler pulley assemblies generally comprise a pulley that is rotatably mounted to a non-rotating member. The pulley is rotatably connected to the member by means of a bearing. The bearing may be a ball bearing type having an inner and outer race. In common arrangements, the inner race of the ball bearing is positioned on an axle bolt, much like a wheel is positioned on an axle. The axle bolt is then connected to the non-rotating member, often by a threaded mechanical connection. The idler pulley is then attached to the outer race of the ball bearing. The outer race and the pulley rotate together. Additionally, a spacer is often provided in between the inner race of the ball bearing and the axle bolt. This serves several purposes, first of which is to create a good fit in between the bearing and axle bolt, and to properly align the bearing. Also, since the spacer is typically made from a plastic type material, it is cheaper to adjust the size of a spacer to accommodate different sizes of axle bolts, as opposed to adjusting the size of the more expensive bearing. This practice is commonplace, as axle bolt sizes are often changed in order to properly attach to various non-rotational members.

It is common practice to additionally place a load spreader between the bearing and the shoulder of the non-rotating member. It has been found that this helps to disperse the thrust loads acting on the bearing/shoulder junction point. This in turn, increases bearing life, which increases the life of the idler pulley assembly, and thereby decreases maintenance costs.

However, it has been customary practice to attach the load spreader directly to the axle bolt. A typical load spreader is comprised of a washer-type member with a plurality of teeth extending into the centralized bore, perhaps slightly angled. The teeth act to both engage the axle bolt, and to also centrally locate the load spreader in relation to the axle bolt. This in turn has caused several problems, both in assembly of the idler pulleys, as well as in inventory logistics. In assembly, the load spreader is threaded onto an axle bolt, which means it has to be both rotated and pushed into proper position. This has caused several problems, as the teeth of the load spreader often foul up the threads of the axle bolt, and the process of placing it in position is cumbersome and inefficient. Further, since several different sizes of axle bolts are utilized, several different sizes of load spreaders are required to be in inventory, so that manufacturing may proceed at a reasonable pace. This practice is both expensive, and inefficient.

What is needed is a single load spreader that will work with any size of axle bolt, yet still provide the adequate load dispersion needed to extend the life of the bearing.

### SUMMARY OF THE INVENTION

Accordingly, it is an aspect of this invention to provide a load spreader for use in pulley assemblies, where the load spreader engages the bearing and not the axle bolt, thereby allowing a single sized load spreader to be utilized with various sized axle bolts. The load spreader comprises a planar surface having a bore, and at least two arms disposed about the bore, with the arms extending substantially perpendicular from the planar surface which engage a bearing inner surface.

The above and other features and advantages of the invention will be apparent in the following detailed description.

### BRIEF DESCRIPTION OF THE DRAWINGS

FIG. 1 is a sectional perspective view of a prior art load spreader;

FIG. 2 is a sectional perspective view of an idler pulley assembly incorporating a prior art load spreader;

FIG. 3 is a sectional perspective view of a load spreader in accordance with the present invention;

FIG. 3A is a sectional view of a load spreader and bearing in accordance with an embodiment of the present invention;

FIG. 4 is a sectional perspective view of an idler pulley assembly incorporating a load spreader in accordance with the present invention;

FIG. 5 is an exploded view of a method of assembly of an idler pulley assembly incorporating a load spreader in accordance with the present invention; and

FIG. 6 is a sectional perspective view of a load spreader with a dust shield in accordance with the present invention.

### DISCLOSURE OF THE INVENTION

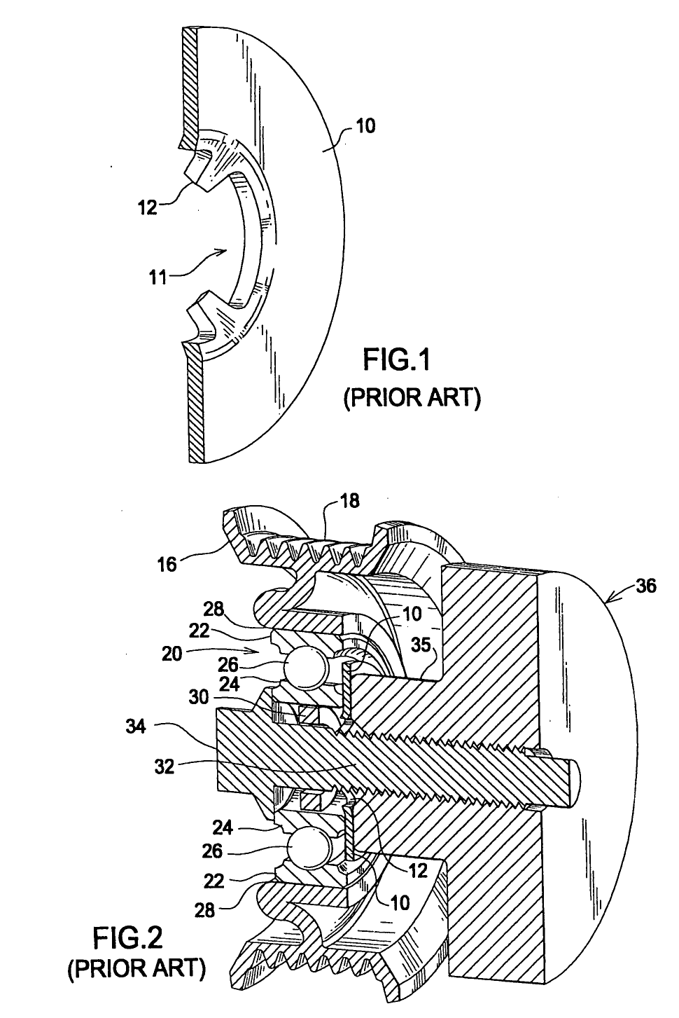

Referring to FIG. 1, a typical prior art load spreader is comprised of a planar portion 10, having a bore (shown generally at 11), and a plurality of teeth 12. Typically, the planar portion 10 is formed much like a standard washer as used in nut and bolt configurations, and is round to mate with an adjacent bearing. The bore 11 is configured to allow an axle bolt to pass through, and the plurality of teeth 12 are configured to engage to the axle bolt. The plurality of teeth 12 of the prior art are typically short to maintain rigid stability during the assembly process which requires the load spreader to screw into place on an axle bolt, as well as maintain a fixed position once in place. The plurality of teeth 12 may be slightly angled, as illustrated, but must be reasonably co-planar with the planar portion 10 of the load spreader in order to allow the teeth 12 to properly engage the axle bolt.

FIG. 2 illustrates an idler pulley assembly incorporating the prior art load spreader. In this configuration, a pulley 16, with a belt bearing surface 18, encircles a bearing, shown generally at 20. A typical bearing comprises an outer race 22, and inner race 24, and a plurality of ball bearings 26 disposed between the races. The bearing 20 is usually press fit within a centralized bore 28 of the pulley 16. An axle bolt 32, with a head 34 which is typically used to maintain proper axial alignment of the pulley assembly, is positioned through a centralized bore of the bearing 20. A spacer 30 is sometimes utilized to both properly align the axle bolt 32 in relation to the bearing 20, and allow for different sized axle bolts 32 to be used with a standard sized bearing 20. A prior art load spreader 10 is positioned on the axle bolt 32 so that the plurality of teeth 12 are engaged with the axle bolt 32. In operation, the load spreader disperses axial load from the bearing 20 to the shoulder 35 of the non-rotational member 36. The axle bolt 32 connects the bearing assembly to the non-rotational member 36, usually by screwing into the non-rotational member.

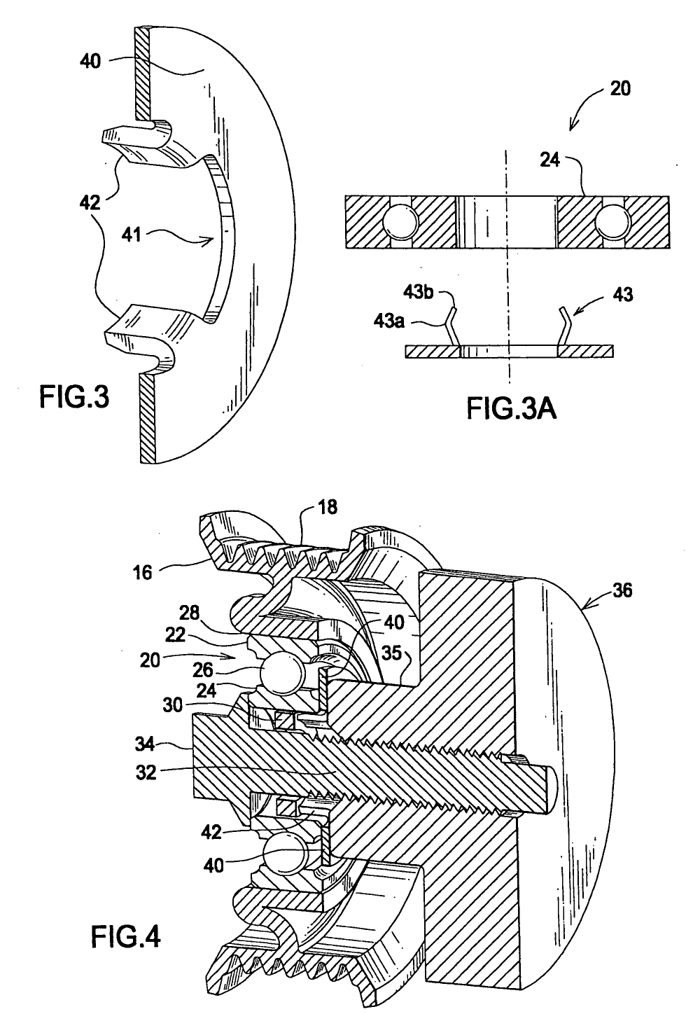

Referring to FIG. 3, an inventive load spreader will now be described. A load spreader is comprised of a planar surface 40, having a bore (shown generally at 41), and a plurality of snap fit arms 42. The bore 41 is generally larger than the bore of a prior art load spreader, as the bore of the present invention is associated more with an inside diameter of the bore of the adjacent bearing, rather than being associated with an outside diameter of the axle bolt, as is the prior art.

The plurality of snap fit arms 42 of the present invention are configured to mechanically engage with an inside diameter of the bore of an adjacent bearing. As such, the plurality of snap fit arms 42 are substantially perpendicular to the planar surface 40. The plurality of snap fit arms 42 are typically comprised of three or four snap fit arms, but may be more or less depending on the size of the bearing to which the snap fit arms mate. Each of the snap fit arms 42 may be planar, as illustrated in FIG. 3, thereby relying on manufacturing tolerances to insure a proper fit, or the snap fit arms 43 may comprise a non-planar, multi-directional protrusion, getting larger (shown generally at 43a) in overall diameter then smaller (shown generally at 43b), and providing a snap-fit into place, as shown in FIG. 3A. In this manner, the plurality of snap fit arms 43 each exert a radial force on the inner race 24 of a bearing (shown generally at 20), thereby holding the load spreader in position.

FIG. 4 is similar to FIG. 2, in that it shows a pulley 16, with a belt bearing surface 18, encircling a bearing (shown generally at 20) comprising an outer race 22, and inner race 24, and a plurality of ball bearings 26, an axle bolt 32 which is positioned through a centralized bore of the bearing 20, and a spacer 30 which is sometimes utilized to both properly align the axle bolt 32 in relation to the bearing 20, and allow for different sized axle bolts 32 to be used with a standard sized bearing 20. However, FIG. 4 utilizes a load spreader of the present invention, with a planar surface 40 dispersing radial loads from the bearing 20 to the shoulder 35 of a non-rotational member 36. A plurality of snap fit arms 42 mechanically engage with the inner race 24 of the bearing 20. In this manner, the plurality of snap fit arms 42 are associated with the bearing 20, and not with the axle bolt 32. This allows for different sizes of axle bolts to be used without having to change the configuration of the load spreader.

The non-rotational member 36 may be, but is certainly not limited to, a bracket, engine block, or tensioner arm, depending on the specific application of the pulley assembly. The axle bolt 32 typically screws into the non-rotational member, however this is not a requirement, and it is contemplated that the axle bolt 32 may be connected by other means, such as a press fit, or any other substantially secure means. Also, axle bolt 32 is illustrated having a head 34, however it is contemplated that axle bolt 32 may have several different configurations, and having a head is not a requirement of the present invention. Additionally, although the bearing 20 is illustrated as a ball bearing, it is contemplated that any bearing known in the art which provides adequate rotational qualities for the pulley 16 may be used within the meaning of this invention.

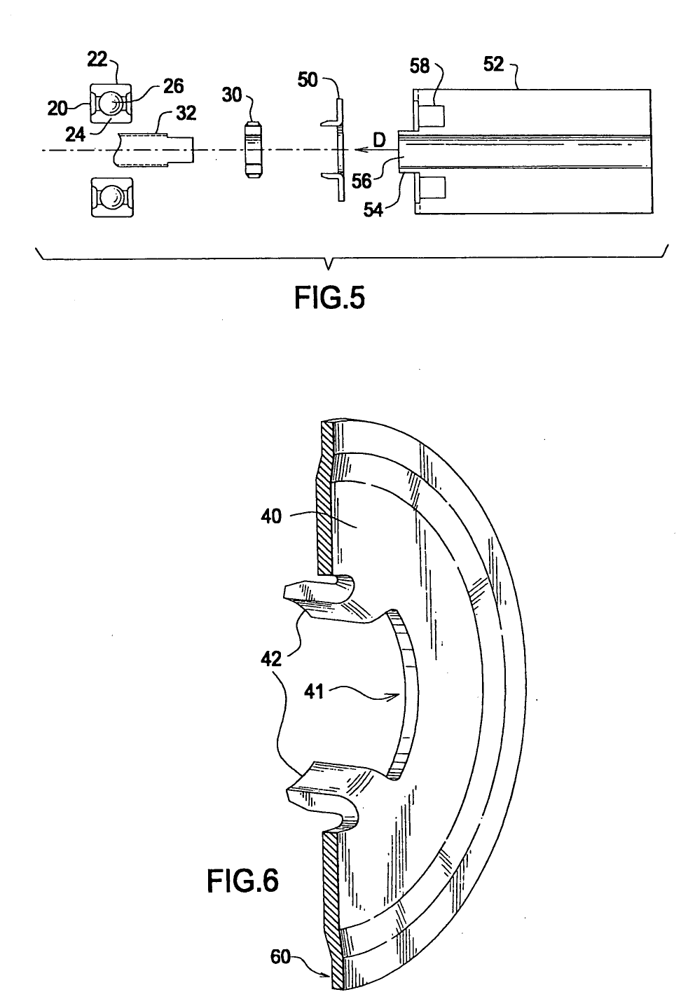

FIG. 5 is illustrative of a method of assembly of an idler pulley assembly, and a tool used to implement such a method. The assembly tool 52 is generally comprised of an elongated cylinder body, having a bore 56 along its elongated axis, to allow an axle bolt 32 to pass through without obstruction. The assembly tool 52 further has a flange 54 and at least one magnet 58 which holds a load spreader 50 in place for assembly. As such, it is preferred that the load spreader 50 is metallic in nature, preferably steel, so that the magnet 58 can hold it in place. However, it is contemplated that a load spreader does not have to be metallic in nature, and that any substantially rigid material will work.

To assemble an idler pulley, an axle bolt 32 is placed through the centralized bore of a bearing 20. Spacer 30 is placed on the end of the axle bolt 32. Again, it is contemplated that a spacer 30 is not required in an idler pulley assembly, but is preferred. The load spreader is then placed about the flange 54 of the assembly tool 52, where the magnet or magnets 58 hold it in place. The assembly tool 52 is then positioned so that the axle bolt 32 is aligned with the bore 56, and the assembly is then “pushed” together in direction D. In this manner, the spacer 30 is held in relative position by both the load spreader 50 and the flange 54 of the assembly tool 52, while the axle bolt 32 passes through the bore 56. The assembly is “pushed” together until the load spreader 50 arms 42 mechanically engage the bearing inner bore. Preferably, the length of the snap fit arms of the load spreader 50, as well as the shoulder 54 of the assembly tool 54, are configured so that the spacer 30 is positioned centrally in the bearing 20.

FIG. 6 represents a second preferred embodiment of the load spreader. Again, the load spreader is comprised of a planar surface 40, having a bore 41, and a plurality of snap fit arms 42 which extend substantially perpendicular to the planar surface 40. However, this second embodiment additionally has a dust shield 60, which is an extension of the planar surface 40. The dust shield 60 may be a simple extension of the planar surface 40, or may be beveled as is illustrated in FIG. 6. The dust shield 60 works to protect the bearing race from the elements, such as dust, grit, oil, and water, as its name implies. A typical load spreader only extends radially to cover the inner race of a bearing, however this embodiment would preferably radially extend to cover the entire bearing, although any radius of the load spreader is contemplated within this disclosure.

Although a specific preferred embodiment has been described with reference to the accompanying drawings herein, it is to be understood that the invention is not limited to that precise embodiment, and that various changes and modifications may be effected by one skilled in the art without departing from the scope or spirit of the invention as defined in the appended claims. Moreover, the invention illustratively described herein may be practiced in the absence of any element that is not specifically disclosed herein.

1. A load spreader for mounting a bearing having an inner surface, said load spreader comprising:
a substantially planar surface of a substantially rigid material, said planar surface describing a bore; and
at least two arms disposed about said bore, said arms extending substantially perpendicular from said planar surface, said arms disposed to mechanically engage with an inner surface of a bearing to axially align said load spreader to the bearing.

2. The load spreader of claim 1 further comprising:
a second planar surface extending radially from said planar surface.

3. The load spreader of claim 1, wherein said arms are each non-planar.

4. The load spreader of claim 1, wherein said substantially rigid material is a metal.

5. The load spreader of claim 4, wherein said metal is steel.

6. An idler pulley assembly comprising:
a pulley having a central bore;
a bearing having a central bore, said bearing being positioned within the central bore of said pulley;
a non-rotational member;
an axle bolt extending through the central bore of said bearing and connecting to said non-rotational member; and
a load spreader having a bore and at least two arms, said arms mechanically engaged with an inner surface of said bearing so that said load spreader is disposed between said bearing and said non-rotational member and circumferentially around said axle bolt.

7. The idler pulley assembly of claim 6 further comprising:
a spacer disposed between said axle bolt and said inner surface of said bearing.

8. A method of assembling a pulley assembly, said method comprising:
inserting an axle bolt through a bearing;
holding a load spreader is position with at least one magnet;
inserting the axle bolt through the load spreader; and
pushing the load spreader toward the bearing until the load spreader mechanically engages an inner surface of the bearing.

9. The method of assembling an idler pulley assembly of claim 8 further comprising:
placing a spacer around the axle bolt prior to inserting the axle bolt through the load spreader.

10. A tool to assemble a pulley assembly, said tool comprising:
a body having a bore, and having at least one magnet positioned radially outside the bore; and
a face adjacent said at least one magnet, said face being substantially planar so that a load spreader may lay substantially flat against said face.

11. The tool to assemble an idler pulley assembly of claim 10, further comprising:
a flange extending substantially perpendicular from said face, said flange positioned between said at least one magnet and the bore.
